(19) United States
(12) Patent Application Publication
(10) Pub. No.: US 2011/0018183 A1
(43) Pub. Date: Jan. 27, 2011

(54) CLAMP, GAUGE AND SUPPORT TOOL FOR LAPBOARD SIDING INSTALLATION

(76) Inventor: Shaun Robert Monteer, Eagle Mountain, UT (US)

Correspondence Address: ANGUS C. FOX, III, 4093 N. IMPERIAL WAY, PROVO, UT, 84604-5386, US

(21) Appl. No.: 12/808,181

(22) PCT Filed: Dec. 15, 2008
(86) PCT No.: PCT/US2008/086899

§ 371 Date: Sep. 13, 2010

Related U.S. Application Data
(60) Provisional application No. 61/006,006, filed on Dec. 14, 2007.

(51) Int. Cl. B23Q 1/25

(52) U.S. Cl. 269/55

(57) ABSTRACT

Method and apparatus are provided for installing lapboard siding on vertical surfaces. The apparatus is a tool which clamps to the last-installed lapboard and utilizes the bottom edge of that last installed board as a reference for installing the next lapboard. The tool, which requires no nailing to secure it, is essentially a specialized C-clamp having a platen which slides between the last-installed and next-to-the-last-installed lapboards. The clamp has a stop bench that is perpendicular to the platen. With the stop bench firmly seated against the bottom edge of the last-installed board, a clamping knob is rotated, thereby clamping the last installed board between a clamping disc and the platen. A next-board shelf secured to a top portion of the specialized C-clamp is adjustable in height to set board overlap.

This application has a priority date based on U.S. Provisional Patent Application No. 61/006,006 by the same inventor, and which has a filing date of Dec. 14, 2007.

### FIELD OF THE INVENTION

The present invention relates, generally, to lapboard siding installation tools and, more particularly, to a tool designed to clamp to the last installed board and provide gauged spacing and support for the next board.

### BACKGROUND OF THE INVENTION

Modern frame construction typically includes a framework of 2×4 or 2×6 boards covered, first, with wafer board sheathing and then a moisture barrier sheet. The exterior layer can chosen from a variety of available materials, including stone, brick, stucco, board and bat, vinyl siding, and lapboard siding. The present invention is associated with the installation of lapboard siding. The installation of lap siding boards on vertical surfaces is awkward because of the length of individual boards. Traditional installation methods have required the presence of at least two installers so that one installer could position and hold each end of a siding board as it was secured to the wafer board sheathing. The procedure, of course, assumes that both installers are using the same gauging methods so that all of the lap siding boards will be installed level and evenly spaced.

Heretofore, the most effective installation tool for lapboard siding was a cement board siding hanger bearing the trademark “Hang-n-Nail”, which is supplied by Allyn Rehm Co., Ltd., a company which seems to be based in Germany. The device may be ordered at www.hanqnnail.com. The company has filed U.S. Provisional Patent Application No. 60/1,864,684 covering the device. The tool, which is designed solely for use with cement lapboard siding, is unadjustable and is set for 1¼ inch board overlap. In order to use the tool, a pair of tabs on the back side of the tool rest on the top edge of the last installed board. The top of the tool is then nailed to the vertical surface, and preferably through the sheathing into a stud for adequate support. A slot on the front side of the tool receives the next board to be installed. After that board is secured to the vertical surface, the support nail is removed, and the tool is extracted from the boards. Although the Hang-n-Nail tool definitely speeds installation of cement lapboard siding, using a support nail to secure the tool to the vertical surface, removing the support nail and extracting the tool from the installed boards is time consuming.

What is needed is a new type of tool, which does not require nailing to secure it to the vertical surface, and which is adjustable to accommodate different amounts of overlap and different thicknesses of lapboard siding. In addition, the tool should be readily removable from installed boards so that it can be quickly set up to receive the next lapboard.

### SUMMARY OF THE INVENTION

The present invention provides a method and apparatus for installing lapboard siding on vertical surfaces. The apparatus is a tool which clamps to the last installed lapboard and utilizes the bottom edge of that last installed board as a reference for installing the next lapboard. The tool, which requires no nailing to secure it, is essentially a specialized C-clamp having a platen which slides between the last-installed and next-to-the-last-installed lapboards. The clamp has a stop bench that is perpendicular to the platen. With the stop bench firmly seated against the bottom edge of the last installed board, a clamping knob is rotated, thereby clamping the last installed board between a clamping disc and the platen. A next-board shelf is adjustable in height to set board overlap. Slippage of the next-board shelf is prevented by employing two engaging surfaces of saw-tooth cross section, which interlock which tightened against one another with threaded fasteners spanning a backing plate and the next-board shelf. Next board shelves of various heights can be supplied to accommodate lapboard siding of different widths. As eight-inch and twelve-inch wide boards are the norm, two sets of next-board shelf components are supplied with the tool. A scale is provided on the main body of the clamp, gauge and support tool for both sizes of next-board shelves. As the clamping member is attached to a threaded clamping shaft with a ball and socket joint, clamping member stops are provided which ensure that the board contact surface of the clamping member surface is parallel to the platen when the clamping knob is fully retracted. The backing plate has an upward extension that is equipped with a belt hook hanger aperture. During manufacture of the tool, the ball at the end of the threaded clamping shaft is inserted within a hemispherical socket machined in the clamping member, and the mouth of the hemispherical socket is swaged in order to secure the clamping member to the threaded clamping shaft. A roll pin is used to secure the clamping knob to the threaded clamping shaft so that, in case of ball and socket joint failure, a new clamping member and threaded clamping shaft assembly can be replaced as a factory-swaged unit.

### BRIEF DESCRIPTION OF THE DRAWINGS

FIG. 1 is a left-side elevational view of the new clamp, gauge and support tool for lap siding installation;

FIG. 2 is a front elevational view of the clamp, gauge and support tool;

FIG. 3 is a right-side elevational view of the clamp, gauge and support tool;

FIG. 4 is a rear elevational view of the clamp, gauge and support tool;

FIG. 5 is an exploded left-side elevational view of the clamp, gauge and support tool configured for 8-inch-wide siding boards, in addition to two optional board thickness adjustment spacers;

FIG. 6 is an isometric view of a one-quarter-inch thick board thickness adjustment spacer;

FIG. 7 is an exploded left-side elevational view of the clamp, gauge and support tool configured for 12-inch-wide siding boards;

FIG. 8 is a rear elevational view of the main body of the clamp, gauge and support tool;

FIG. 9 is a left-side elevational view of the main body of the clamp, gauge and support tool;

FIG. 10 is a front elevational view of the main body of the clamp, gauge and support tool;

FIG. 11 is a rear elevational view of the next board shelf of the clamp, gauge and support tool;

FIG. 12 is a left-side elevational view of the next board shelf of the clamp, gauge and support tool;

FIG. 13 is a front elevational view of the support bracket of the camp, gauge and support tool;

FIG. 14 is a rear elevational view of the backing plate of the clamp, gauge and support tool;

FIG. 15 is a left-side elevational view of the backing plate of the clamp, gauge and support tool;

FIG. 16 is a front elevational view of the backing plate of the clamp, gauge and support tool;

FIG. 17 is a rear elevational view of the platen of the clamp, gauge and support tool;

FIG. 18 is a left-side elevational view of the platen of the clamp, gauge and support tool;

FIG. 19 is a front elevational view of the platen of the clamp, gauge and support tool;

FIG. 20 is a left-side elevational view of the clamp, gauge and support tool and an end view of lap siding boards undergoing installation against a sheathing layer, with the tool clamped to the uppermost and last-installed piece of lapboard siding;

FIG. 21 is a view of the assembly of FIG. 19 following the positioning of an additional siding board on the support bracket of the clamp, gauge and support tool;

FIG. 22 is a view of the assembly of FIG. 20 following loosening of the clamping screw and removal of the clamp, gauge and support tool from the piece of lapboard siding to which it was clamped; and

FIG. 23 is a view of the assembly of FIG. 21 following insertion of the platen of the clamp, gauge and support tool beneath the last installed piece of lapboard siding and tightening of the clamping screw to secure the tool to the last-installed piece of lapboard siding.

### PREFERRED EMBODIMENT OF THE INVENTION

The invention will now be described with reference to the attached drawing figures. It should be understood that the drawings are meant to be merely illustrative, and are not necessarily drawn to exact scale.

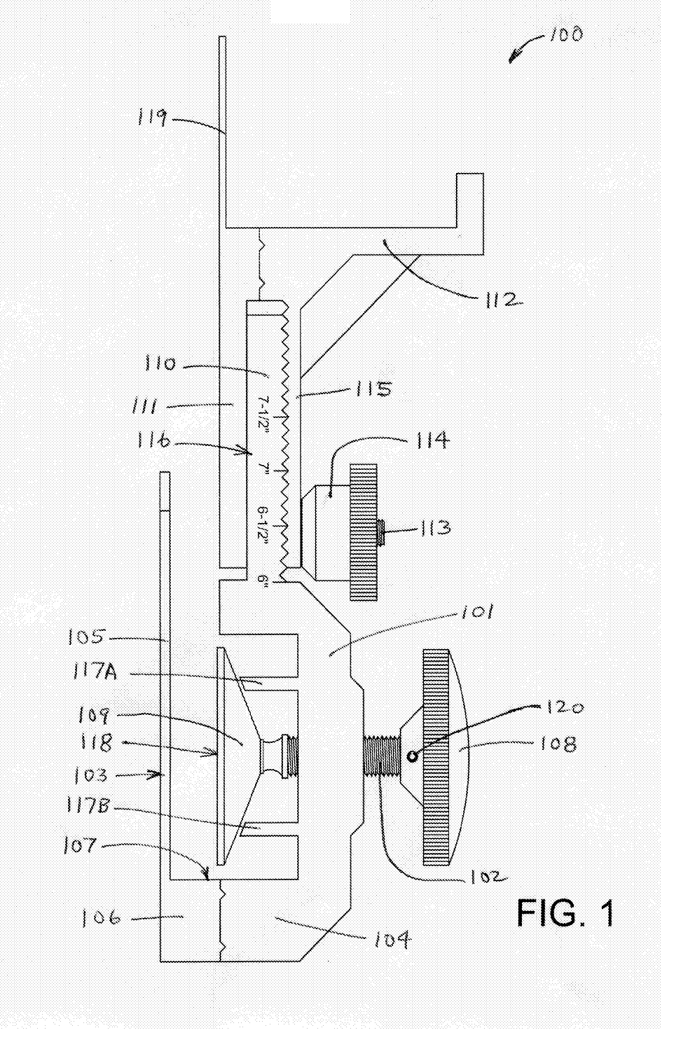

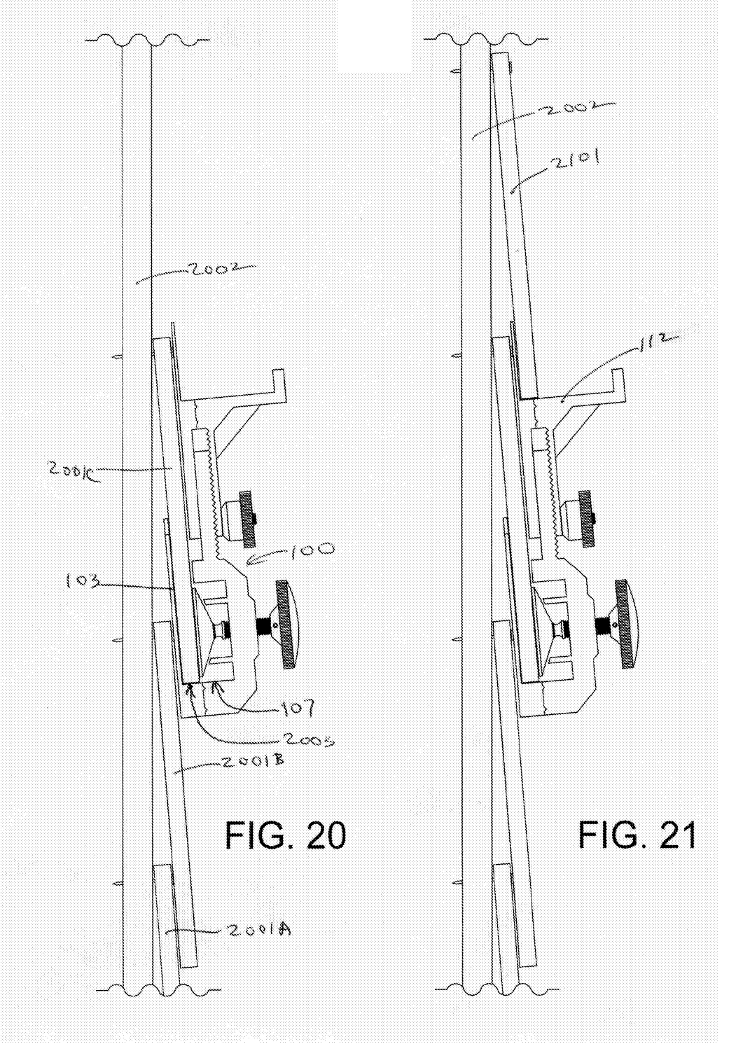

Referring now to FIG. 1, the new clamp, gauge and support tool 100 for lap siding installation is shown fully assembled. The tool 100 is essentially a specialized C-clamp having a main body 101 threaded to receive a threaded clamping shaft 102 and a platen 103, which is secured to a lowermost portion 104 of the main body 101. The platen 103, which is preferably made of a durable structural metal, such as high-strength steel, stainless steel or titanium, has a laminar vertical upper portion 105 that is sufficiently thin so that it can be slid between the last-installed and next-to-the-last-installed lapboards. Use of the tool 100 will be fully described with reference to drawing FIGS. 20 to 23. The lowermost portion 104 of the main body 101 and a lowermost portion 106 of the platen 103 together form a stop bench 107 that is perpendicular to the vertical laminar portion 105. With the stop bench 107 firmly seated against the bottom edge of a last installed lapboard, a clamping knob 108 attached to one end of the threaded clamping shaft 102 is rotated in a clockwise direction, thereby displacing a clamping member 109 toward the outer surface of the last installed lapboard. The clamping knob 108 is tightened in order to secure the last installed lapboard between the clamping member 109 and the platen 103. An upper portion 110 of the main body 101 is compressed between a backing plate 111 and a next-board shelf 112 with threaded fasteners, which include a bolt 113 having a low profile head (not shown in this view) and knurled finger nut 114. Slippage of the next-board shelf 112 is prevented by employing two engaging surfaces of saw-tooth cross section on both a front side of the upper portion 110 of the main body 101 and on a downward projecting extension 115 of the next-board shelf 112. The surfaces interlock when tightened against one another with the threaded fasteners. Next board shelves and backing plates of various heights can be supplied to accommodate lapboard siding of different widths. The next-board shelf 112 and backing plate 111 shown in this drawing figure are designed to accommodate 8-inch wide lapboard siding. It will be noted that a numeric scale 116 etched or stamped into the left side of the upper portion 110 of the main body 101 indicates the height of the next-board shelf 112 above the stop bench 107. As eight-inch and twelve-inch wide lapboards are considered the norm, two sets of next-board shelf components are supplied with the tool. The right side of the upper portion 110 of the main body 101 includes a scale for twelve-inch wide lapboards. As the clamping member 109 is attached to the threaded clamping shaft 102 with a ball and socket joint (not shown in this view), clamping member stops 117A and 117B are provided which ensure that the board contact surface 118 of the clamping member 109 surface is parallel to the platen 103 when the clamping knob 108 is fully retracted. An upward extension 119 of the backing plate 111 is equipped with a belt hook hanger aperture (not visible in this view). During manufacture of the tool, a ball at the end of the threaded clamping shaft 102 is inserted within a hemispherical socket machined in the clamping member 109, and the mouth of the hemispherical socket is swaged in order to secure the clamping member 109 to the threaded clamping shaft 102. A roll pin 120 is used to secure the clamping knob 108 to the threaded clamping shaft 102 so that, in the event of ball and socket joint failure, a the clamping member 109 and threaded clamping shaft 102 can be replaced as a factory-swaged assembly.

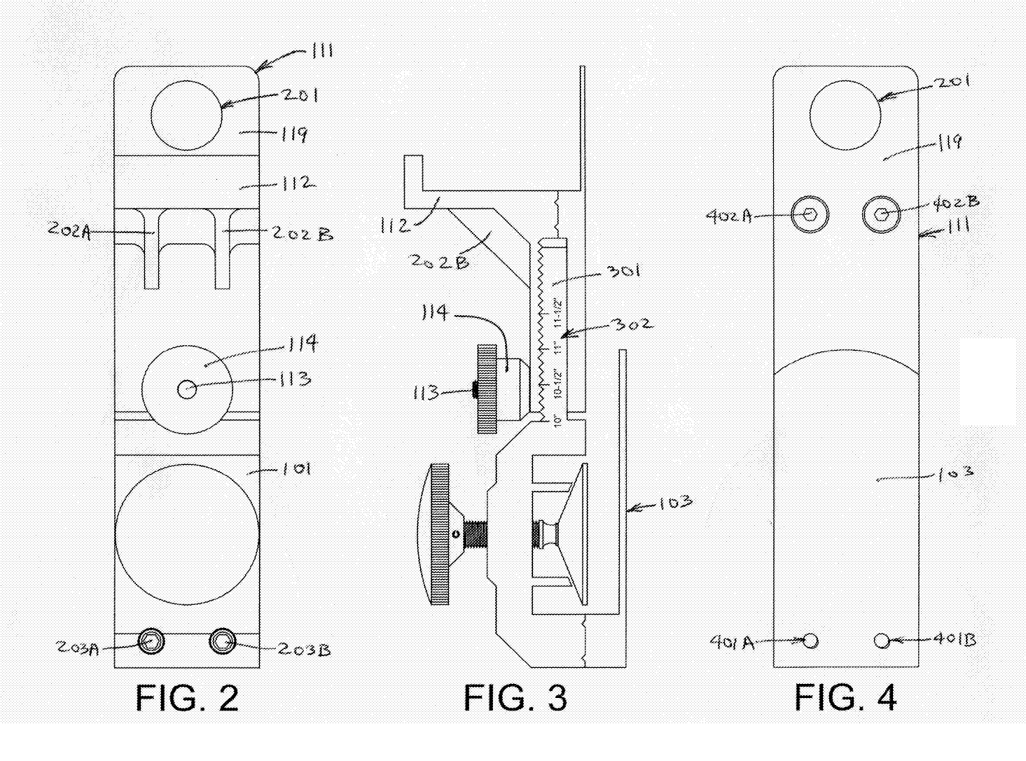

Referring now to the front view of the clamp, gauge and support tool of FIG. 2, the belt hook hanger aperture 201 in the upward extension 119 of the backing plate 111 is visible, as are the main body 101, the next board shelf 112, the bolt 113 having a low profile head, and the knurled finger nut 114. It will be noted that the next board shelf 112 has a pair of triangulated braces 202A and 202B, which provide additional structural integrity to that component. A pair of recessed, cylindrical, socket-head screws 203A and 203B, which secure the main body 101 to the platen 103 are visible in this view.

Referring now to FIG. 3, the clamp, gauge and support tool 100 is shown from the right side. As previously mentioned, the right side 301 of the upper portion 110 of the main body 101 includes a scale 302 for twelve-inch wide lapboards.

Referring now to FIG. 4, the only items visible in this view are the platen 103, a pair of threaded apertures 401A and 401 B in the platen, the ends of the socket-head screws 203A and 203B which engage the threaded apertures 401A and 401 B, respectively, the upward extension 119 of the backing plate 111 containing the belt hook hanger aperture 201, and a pair of identical bevel-head Allen screws 402A and 402B, which secure the upper portions of the backing plate 111 and the next board shelf 111 together.

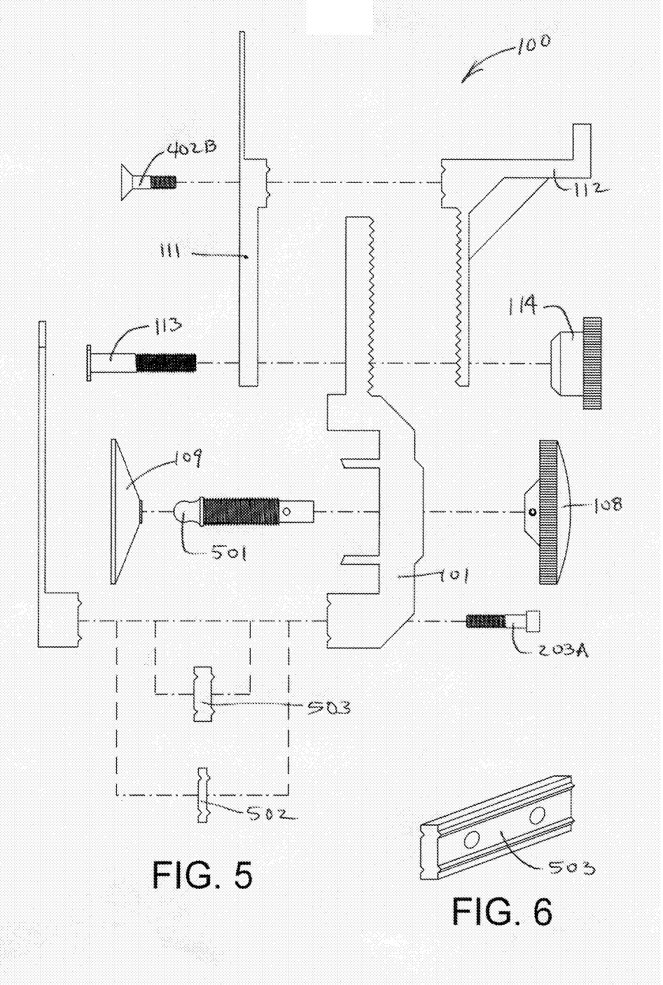

Referring now to FIG. 5, in this exploded view for the clamp, gauge and support tool 100 configured for use with eight-inch wide lapboards, the bolt 113 having a low profile head, the knurled finger nut 114, and the bevel-head Allen screw 402B, which secure the backing plate 111 to the next-board shelf 112 are fully visible in this view, as is cylindrical, socket-head screws 203A, which is used to secure the main body 101 to the platen 103. The ball 501 on the inner end of the threaded clamping shaft 102 is also visible in this view. A pair of optional board thickness adjustment spacers 502 and 503 are visible. Spacer 502 spaces the platen 103 one-eighth inch further from the main body 101; spacer 503 spaces the platen 103 one-quarter inch further from the main body 101. The spacers 502 and 503 enable the clamp, gauge and support tool 100 to be used with siding of all types, including cement board siding, engineered wood siding and real wood siding. All components of the clamp, gauge and support tool 100, except for the platen 103 and screws 203A, 203B, 402A, 402B, bolt 113, threaded clamping shaft 102, and roll pin 120 are fabricated, preferably, from aluminum or aluminum alloys for reduced weight and production costs. Heat treatment of the aluminum components enhances durability. Threaded apertures in the aluminum components can be heli-coiled or bushed with inserts of more durable metal.

Referring now to FIG. 6, the details of the optional one-quarter-inch thick board thickness adjustment spacer 503 more readily visible in this isometric view.

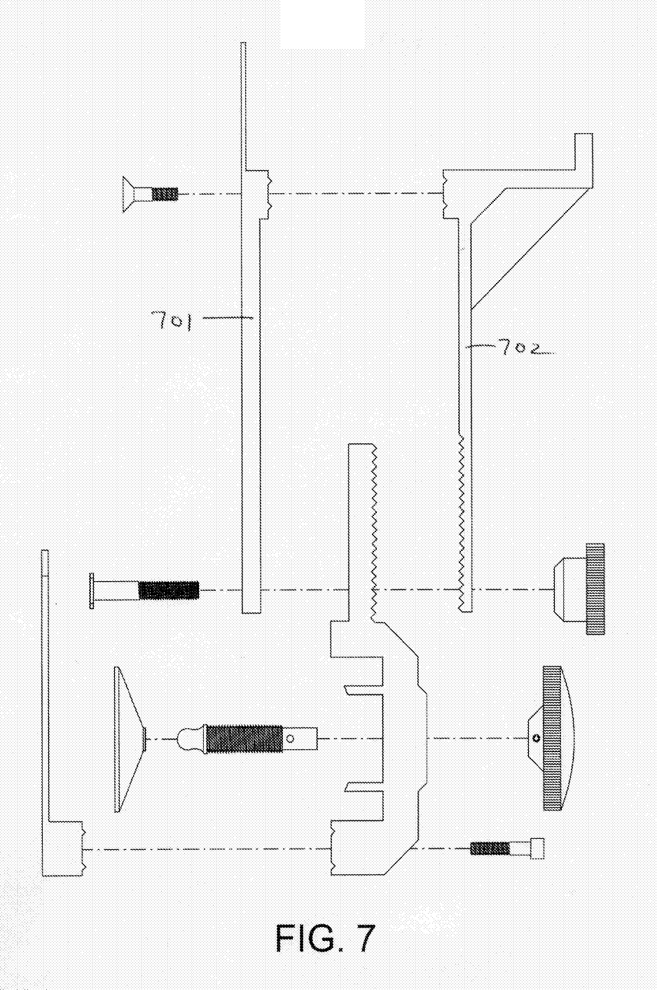

Referring now to FIG. 7, this exploded view of the clamp, gauge and support tool 100 is identical to that of FIG. 5, except that the backing plate 111 and next-board shelf 112 have been replaced with taller versions 701 and 702, respectively that accommodate twelve-inch-wide lapboards.

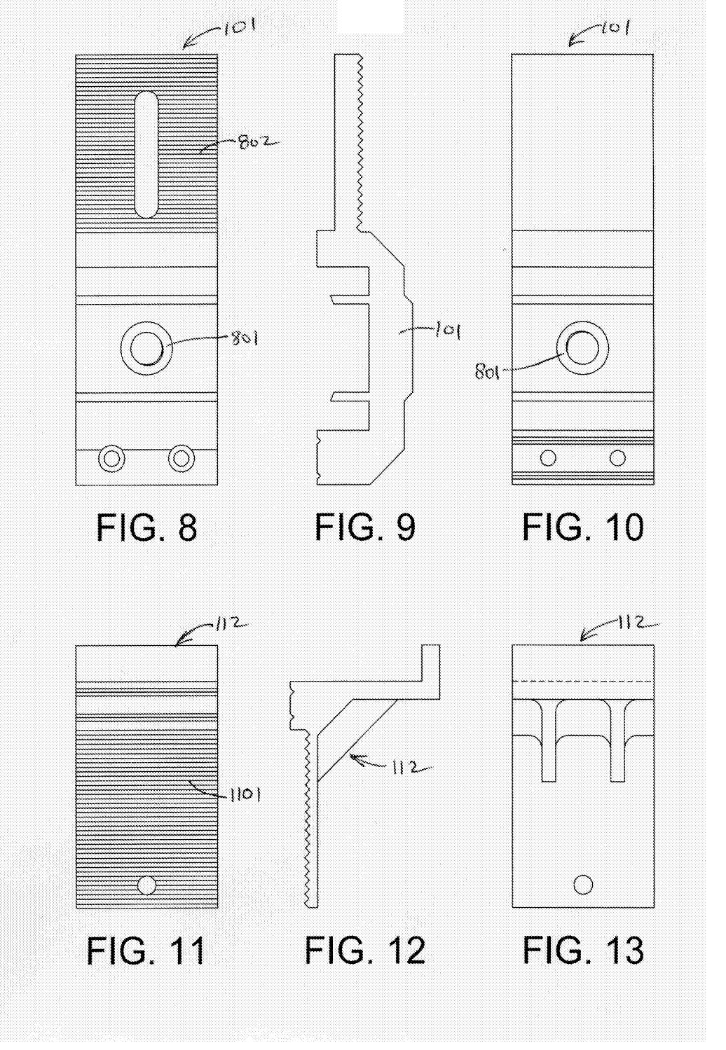

Referring now to FIGS. 8, 9 and 10, the main body 101 is shown from three different angles. It will be noted that an externally-threaded steel, brass, or sintered bronze insert 801 is installed in the main body in order to enhance the life of the female threads that engage the threaded clamping shaft 102. The surface 802 of saw-tooth cross section on the main body 101 is fully visible in FIG. 8.

Referring now to FIGS. 11, 12 and 13, the next-board shelf 112 is shown from three different angles. The surface 1101 of saw-tooth cross section on the next-board shelf 112 is fully visible in FIG. 11.

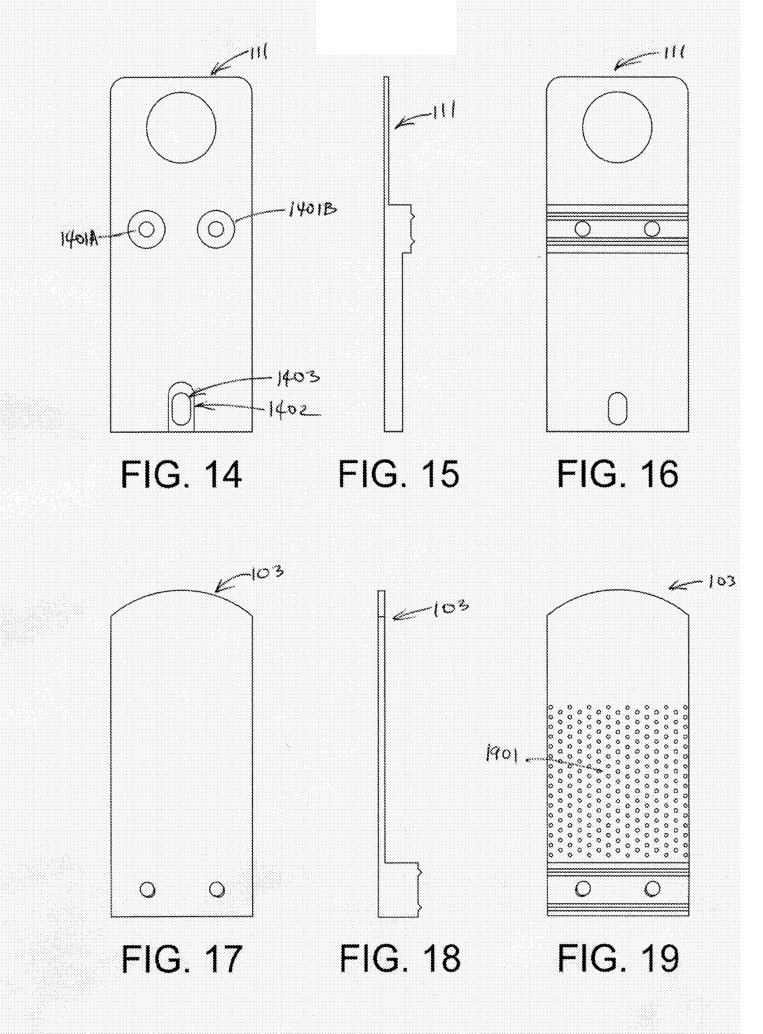

Referring now to FIGS. 14, 15 and 16, the backing plate 111 is shown from three different angles. The belt hook hanger aperture 201 is fully visible in this view, as are a pair of bevel countersunk bolt head recesses 1401A and 1401B. A machined recess 1402, having an oblong aperture 1403 centered therein receives the bolt 113 with the low-profile head.

Referring now to FIGS. 17, 18 and 19, the platen 103 is shown from three different angles. It will be noted that the surface 1901 of the platen 103 which faces the rear of the last-installed lapboard is equipped with a textured surface to enhance secure clamping of the lapboard to the clamp, gauge and support tool 100. Although dimples 1902 are shown in this view, a series of parallel horizontal furrows can be used with similar results.

Referring now to FIGS. 20 to 23, the method of use of the clamp, gauge and support tool 100 is shown in a step-by-step manner. In FIG. 20, three lapboard siding pieces 2001A, 2001B and 2001C are shown nailed to the sheathing 2002 of a wall. The 2×4 or 2×6 framing structure is not shown. It should be noted that preferably, the lapboard siding pieces are secured to the framing structure through the sheathing 2002 for enhanced security during violent storms. The platen 103 of the tool 100 has been inserted between lapboard siding pieces 2001B and 2001C, the stop bench 107 has been firmly pressed against the lower edge 2003 of lapboard siding piece 2001C, and the clamping knob 107 has been rotated in a clockwise direction so that lapboard siding piece is securely clamped between the clamping member 109 and the platen 103.

Referring now to FIG. 21 in particular, a new lapboard piece 2101 has been supported by the next-board shelf 112, and the new lapboard 2101 has been nailed to the sheathing 2002.

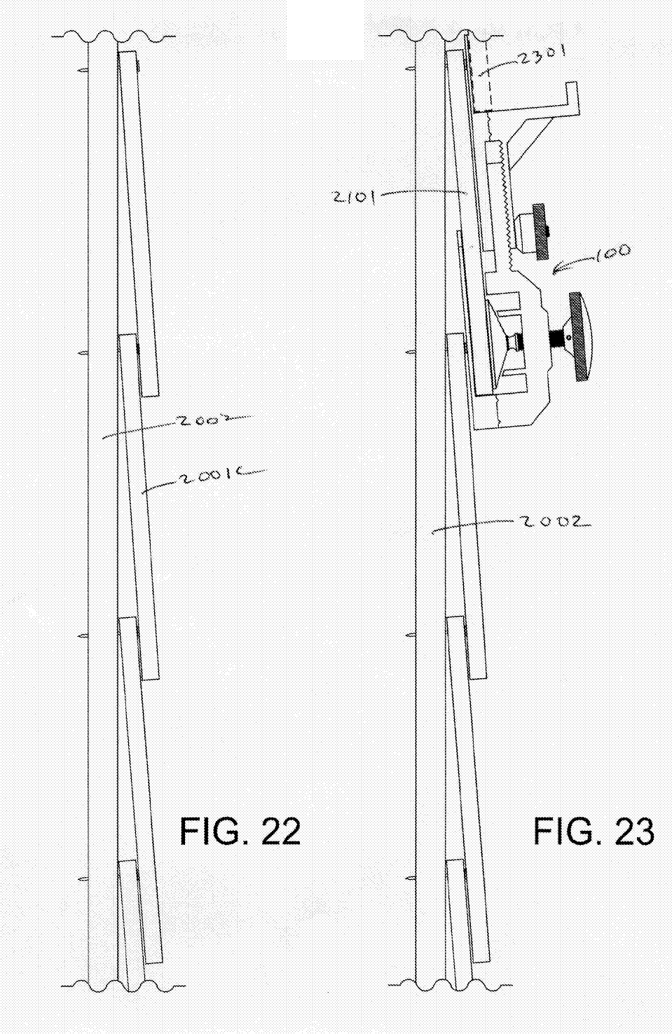

Referring now to FIG. 22, the clamping knob 108 has been rotated in a counter-clockwise direction and the clamping member 109 has been retracted, thereby loosening the clamp, gauge and support tool 100 from lapboard siding piece 2001C. The tool 100 is then removed.

Referring now to FIG. 23, the clamp, gauge and support tool 100 has been reinstalled such that it is clamped to the latest installed lapboard piece 2101. The tool 100 is now ready to support a new lapboard piece, which is represented by the dashed outline 2301.

Time and motion studies have been performed to determine the effectiveness of the new clamp, gauge and support tool. A test structure was constructed and a study conducted on three different installations. The first installation used no helper tool, the second installation used the Hand-n-Nail tool, and the third installation used the tool of the present invention. The test structure was a simple house with typical architectural features to allow realistic installations. The test structure was constructed inside a warehouse located in Spanish Fork, Utah. The overall wall elevation was approximately 17 feet long and 13 feet tall. The gable started at approximately 9 feet and ended at the center apex of the wall. The wall encompassed approximately 220 square feet. James Hardie cementitious siding was used for all installations, which were performed using the nailing required for high wind areas. Installation using the Hang-n-Nail tool took approximately 69 percent of the time required using no “helper” tool. This represents a savings of approximately 32 percent. Installation using the tool of the present invention took approximately 39 percent of the time required using no “helper” tool. The represents a savings of approximately 61 percent. The installation using the tool of the present invention took approximately 57 percent of the time required to make the same installation using the Hang-n-Nail tool. This represents a time savings of approximately 43 percent.

In conclusion, tremendous savings in installation time can be realized using the new clamp, gauge and support tool.

Although only several embodiments of the new clamp, gauge and support tool 100 have been described herein, it will be obvious to those having ordinary skill in either lapboard installation methods or tool design and manufacture that changes and modifications may be made thereto without departing from the scope and the spirit of the invention as hereinafter claimed.

What is claimed is:

1. A clamp, gauge and support tool for lapboard siding installation comprising:
a main body;
a platen secured to the main body, said platen having a having a laminar vertical portion that is insertable between a last-installed piece and a next-to-the-last-installed piece of lapboard siding;
a stop bench which fits against a bottom edge of the last-installed piece of lapboard siding;
a clamping member that can be urged against the last-installed piece of lapboard siding to secure the latter between the platen and the clamping member;
a next-board shelf secured to the main body upon which a new piece of lapboard siding can be supported, said next-board shelf, in combination with the stop bench providing proper spacing between the last-installed piece of lapboard siding and a the new piece of lapboard siding.

2. The clamp, gauge and support tool of claim 1, wherein said next-board shelf is adjustable in height to provide varying amounts of overlap between adjacent pieces of installed lapboard siding installed using said tool.

3. The clamp, gauge and support tool of claim 1, wherein next-board shelves of different heights are provided in order to accommodate lapboard siding of substantially different widths.

4. The clamp, gauge and support tool of claim 1, wherein said clamping member is urged against a last-installed piece of lapboard siding with a threaded clamping shaft to which is coupled a knob rotatable by an installer's hand.

5. The clamp, gauge and support tool of claim 1, wherein the main body is equipped with clamping member stops, which ensure that a clamping surface of the clamping member is parallel to the platen when the clamping member is fully retracted.

6. The clamp, gauge and support tool of claim 1, wherein said next-board shelf has a lower portion with surface of saw-tooth cross section, that mates with a surface of saw-tooth cross section on an upper portion of the main body, and said pair of surfaces of saw-tooth cross section are secured together with threaded fasteners to prevent movement of the next-board shelf with respect to the main body.

7. The clamp, gauge and support tool of claim 1, which further comprises spacers which can be inserted between the platen and the main body to accommodate lapboard siding of varied thicknesses.

8. The clamp, gauge and support tool of claim 1, wherein said tool is equipped with a scale so that an installer can easily set lapboard siding overlap without the use of external measurement devices.
